(19) United States
(12) Patent Application Publication
(10) Pub. No.: US 2010/0238090 A1
(43) Pub. Date: Sep. 23, 2010

(54) SCREEN SEAMING DEVICE SYSTEM AND METHOD

(75) Inventors: Itzhak Pomerantz, Kefar Sabe (IL); Uriel Pomerantz, Kefar Sabe (IL); Yehushua Dollberg, Raanana (IL); Eyal Teichman, Hod Hasharon (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: SPECTRUM DYNAMICS LLC

(21) Appl. No.: 12/594,720

(22) PCT Filed: Apr. 6, 2008
(86) PCT No.: PCT/IL08/00476

§ 371 Date: Jun. 2, 2010

Related U.S. Application Data
(60) Provisional application No. 60/910,437, filed on Apr. 5, 2007.
(60) Provisional application No. 61/033,795, filed on Mar. 5, 2008.

(51) Int. Cl. G09G 5/00

(52) U.S. Cl. 345/1.3

(57) ABSTRACT

The present invention teaches a method for eliminating the visible gaps between screens in a multi screen video wall. This is done by placing optical bridges over the edges of the individual displays, which direct graphical information from the periphery of the individual displays to fill the gaps between said displays. Preferably, commercially available screens are thus combined to form a seamless video wall.

### RELATED APPLICATIONS

This Application claims the benefit of U.S. Provisional Patent Application No. ______ filed ______ and U.S. Provisional Patent Application No. ______ filed ______

### BACKGROUND OF THE INVENTION

Graphic displays are well known in the art of computer engineering. and public entertainment.

There are several technologies that are used to create a graphical display of digital data, such as CRT (example: PHILIPS 107E76 17″ CRT DISPLAY), LCD (Example Sony FWD-32LX1RB LCD Display) and plasma (example: Sony FWD-42PV1VS.

In some situations, the user needs a display of a relatively large size—typically several meters of width and of height—and more data points than can be displayed by a single display. Such displays cannot practically be made in one piece, and are typically composed of a matrix of adjacent displays arranged in rows and columns. Such systems are known in the art as “video walls”.

The digital image is split to the individual displays by processing systems such as the Brick-2 Video Wall Processor available from Media Technologies Ltd. Colchester, United Kingdom.

As display devices are framed in cases with bezels, there is an unavoidable gap between adjacent images, appearing as a visible opaque grid across the video wall.

This grid, made of strips whose width is between several millimeters (in plasma and rear projection displays) and few centimeters (in LCD) are disturbing the visual effect of the video wall.

Unfortunately, the prior art of video walls does not provide practical means for removal of the grid.

FIG. 1 schematically shows a video wall as known in the art. The image spread over four screens, interrupted by the gaps around the screens. When combining multiple screens such as CRT, LCD or plasma video screens to form a large combined screen, the gaps, district from the appearance of the combined display and may cause image distortion and/or data loss. In some cases, the individual screen images are presented in registration with each other and the missing pixels (hidden by the bezels) are omitted. In other cases, all the pixels are represented on the display, and the bezels are slipped. In the first case, the image is missing thousands of pixels. In the second case, the. image is distorted (a diagonal line across the bezel will appear as a broken line). In both cases, the prior art images are distorted.

U.S. Pat. No. 6,496,238; titled “Construction of large, robust, monolithic and monolithic-like, AMLCD displays with wide view angle”; to Greene; Raymond G et.al.; series of techniques for designing and assembling of large, robust monolithic and monolithic-like flat panel displays. Many techniques originally developed for creating tiled, flat-panel displays having visually imperceptible seams may be advantageously applied to monolithic structures. These techniques include single-sided wiring, two-sided wiring from opposite sides, segmented row and column lines, and reordering row and column lines in fan-out region. Single-sided wiring facilitates the construction of displays with small outlines. By using, these techniques, display sharpness and contrast may be improved. In addition, color and luminance balance and uniformity across the display may also be improved.

U.S. Pat. No. 5,903,328; titled “Tiled flat-panel display with the edges cut at an angle and tiles vertically shifted” to Greene, et al.; discloses a tiled, seamless-type, flat-panel display with improved light efficiency. The display consists of tiles that are bonded together during assembly with an index-matching adhesive, as is commonly known in the art.

U.S. Pat. No. 6,967,114; titled “Large EL panel and manufacturing method therefore”; to Shimoda, et al.; discloses a manufacturing method for a large EL panel in which a plurality of EL display panels are used. Each of said plurality of EL display panels are constructed of an EL display device and a sub-transparent substrate. The EL display device includes a base layer over which a luminescent material is applied, an electrode layer which is laminated on one side of said base layer, and a TFT layer including a circuit section. The circuit section of a TFT layer is disposed behind an adjacent EL display device. Thus, the EL display devices appear to be unified; forming a large EL display panel. In addition, in the case of in which a plurality of EL display devices are arranged in a matrix pattern, pitch between the pixels provided in the pixel section of the TFT array is maintained constant.

It would be very desirable to have a mechanism, a device and a method that significantly reduces the visual disturbance of the grid in a multi-screen video wall comprising commercially available or minimally modified displays.

### SUMMARY OF THE INVENTION

The invention will be explained using the following terms, description, drawings and description of drawings.

### Definition of Terms

Light guiding sheet (LGS)—a thin sheet of optical material capable of transmitting a linear image, with small losses, from one edge of the sheet to the opposite edge of the sheet. A light guiding sheet can be made of optical fibers, glued or fused contiguous and parallel to each other. A light guiding sheet can also be made of a thin plate of clear material, such as acrylic or polycarbonate, coated with reflective mirrors on both faces. In this invention, the term “Light guiding sheet” (LGS) means any of these or other means for optically projecting a line-image from one side of the sheet to the other. The LGS can but does not have to be planar, and can be curved. A layer of fibers can be conceived as a sheet LGS.
Video wall—an array of typically co-planar video screens arranged to produce a large video image, fed by a video wall processor that segments the input video image into individual video signals for each screen
Optical bridge—a generally prismatic optical device having two image input surfaces and two image output surfaces, where both input and output surfaces cover the same bounding area. The two input areas cover only a part of the bounding box, leaving a gap between them, and the two output areas cover the complete bounding box, leaving essentially no gap between them. Figures that show a cross section or a side view of an optical bridge, look the same for a fiber LGS and a sheet LGS, as both appear as a one-dimensional line in the cross section. So all the drawings and explanation of drawings in this application that use a cross section or a side view of an optical bridge, apply to both fiber and sheet LGS.
Half Optical Bridge—a generally prismatic optical device having an input and an output surface, both surfaces share one common edge and are not equal in size.
Faceplate—an optical device that conveys, using LGS, an image from an input surface to an output surface. In most faceplates (but not in this application) the input surface is parallel to the output surface. In this invention, the faceplates are typically wedged and the input and output surfaces intersect
Input surface (of a faceplate)—the surface of an optical bridge that is co planar with the screen surface.
Gap—the non active stripe between two neighboring screens in a video wall, typically occupied by the bezel of the screens.
Stitching or seaming—a process done upon erection and calibration of video wall, causing the gaps between the screens to become hardly visible to a viewer.
Output surface (of a faceplate)—the surface of an optical bridge that is facing the viewer. The output surface may be planar, curved or ridged.
Support surface (of a faceplate)—a planar surface of a faceplate that is not used for inputting or outputting light, and is used to support the optical bridge to its place.

### DESCRIPTION OF THE INVENTION AND SOME OF ITS EMBODIMENTS

The present invention teaches a continuous video wall, where the images of adjacent screens appear to be continuous across the gaps between the neighboring screens.

In some preferable embodiments of this invention, an optical strip device is placed over the gap between two displays, covering a part of the active area of both displays and the gap between them.

One embodiment of this invention will be described by reference to a configuration of two displays, a left display and a right display, positioned adjacent to each other with a vertical gap between their image areas. It should be clear that the invention applies also to two displays positioned on top of each other, with a horizontal gap between them.

A vertical optical strip is covering a rightmost vertical image stripe of the left screen, the gap and a leftmost vertical image stripe of the right screen.

The covered part of the active image stripe of the left screen is magnified horizontally by the optical device to extend, when viewed by the user, from the leftmost end of that image stripe to the middle of the gap.

The covered part of the active image stripe of the right screen is magnified horizontally by the optical device to extend, when viewed by the user, from the rightmost end of that image stripe to the middle of the gap.

The result is that the user sees a continuous image across the gap.

In a preferred embodiment of the present invention, the image on each of the screens is pre-distorted for example by software, so that the data points that were part of the image and were omitted because they would have been displayed in the gap will be represented distortedly inside the viewable image in the area covered by the vertical optical strip. After the optical magnification mentioned above, the image resumes its correct scale and the data points that were not displayed originally appear to be displayed on the optical strip.

The two active image stripes can be described as “donor” area, as they system “harvests” image pixels from them, using them to serve the gap areas, that can be described as “recipient” areas. The horizontal graphical resolution of the magnified image is reduced, due to the magnification, by an amount that depends on the ratio between the width of the “donor” area and the width of the “recipient” area. (in optical terms—between the width of the input surface and the width of the output surface of the face plate). If, by way of example, the bezel of the screen is 15 mm wide, and the width of the “donor” area is 5 mm, then the resolution of the “recipient area” will be reduced by a factor of 4—as information collected across 5 mm, has to “feed” an area of 20 mm. The width of the optical device, in this case, will be 40 mm end-to-end, serving both displays. lf, in another example, the width of the optical device is 60 mm-30 mm on each display—then the “donor” area will be 15 mm, and the resolution will only be reduced by a factor of 2.

In another preferred embodiment, all the horizontal gaps between the vertically displaced screens are covered with horizontal optical bridges that translate the omitted data lines between the displays.

In another preferred embodiment, all the gaps between the screens are covered with optical bridges.

In another preferred embodiment, the strips are shorter than the edge of the screen, and extend only until they would cross each other, leaving the corners of the screens uncovered, so that small square areas in the corners common to four screens remain absent form the image.

In another preferred embodiment of the invention, the corners between four neighboring screens are covered by a square device having four input surfaces and four output surfaces.

In another preferred embodiment of the invention, the optical bridge consists of prismatic faceplates.

In another preferred embodiment of the invention, the optical bridge consists of light guide plates.

According to an embodiment of the invention, a composite video wall is provided comprising plurality of video displays each having plurality of pixels and each having a non image displaying bezel wherein said composite video wall is capable of displaying a substantially undistorted gapless image having effective number of pixels substantially equal to number of pixels in all said plurality of video displays.

According to an embodiment of the invention, a method of stitching a video wall, is provided said method comprising the steps of: (a) providing at least two adjacent video displays having a gap between them; (b) providing at least one optical bridge covering the gap between said video displays; and (c) projecting optical image of at least a portion of image from at least one of said video displays into gap between said video displays.

In some embodiments the method further comprises the steps of: (a) pre-processing image in at least a portion of at least one of said video displays to at least partially compensate the visual effect of said optical bridge on the image; and (b) displaying said pre-processed image on said at least two adjacent video displays.

In some embodiments the pre-processing comprises scaling in at least one dimension.

In some embodiments the pre-processing comprises brightness modification.

In some embodiments the visual effect is attenuation.

In some embodiments the step of projecting optical image of at least a portion of image from at least one of said video displays into gap between said video displays is performed by said at least one optical bridge.

In some embodiments the step of projecting optical image of at least a portion of image from at least one of said video displays into gap between said video displays comprising at least translation and stretching of said portion of image from at least one of said video displays.

In some embodiments each of said at least one optical bridges comprises plurality of optical guides.

In some embodiments the optical guides are optical fibers.

In some embodiments at least one of said optical guides is a strip of transparent material coated with reflective layer over its large face.

Another aspect of the invention is to provide a composite video wall comprising: plurality of video displays, each having plurality of pixels, and each having a non image displaying bezel; and at least one optical bridge covering at least on of said bezel, wherein said composite video wall is capable of displaying a substantially, undistorted gapless: image having effective number of pixels substantially equal to number of pixels in all said plurality of video displays.

Another aspect of the invention is to provide a method of producing an optical bridge comprising the steps of: (a) providing an extruded comb shaped flexible clear object having multiple strips conceded to each other; (b) coating at least part of the surface of said strips with a thin layer of an optically reflective material; (c) compressing said comb shaped flexible clear object to bring the coated strips to a close proximity with each other; and (d) fixing the object in its compressed shape.

The present invention will be better understood from the drawings and their explanation.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 schematically shows a 2-by-2 screens video wall, showing an image and having gaps according to methods used in the art.

FIG. 2 schematically shows a cross section of a prismatic fiber-optic face plate according to an exemplary embodiment of the current invention.

FIG. 3A schematically shows an enlarged view of full optical bridge in operation according an exemplary embodiment of the current invention.

FIG. 3B schematically shows a half optical bridge according to an exemplary embodiment of the current invention.

FIGS. 4A and 4B schematically show method of producing half-optical-bridges from a fiber optics block using an economic nesting of half-optical-bridges according to exemplary embodiment of the current invention.

FIGS. 5A-5D schematically depict show an exaggerated layout of the video wall as seen in the art (5A) and as corrected using the device and method according to an exemplary embodiment of the current invention (5D).

FIG. 6 schematically shows a cross section of an optical bridge used with screen having raised bezel according to another exemplary embodiment of the current invention.

FIG. 7 schematically shows a cross section of a smooth face plate according to another exemplary embodiment of the current invention.

FIG. 8 schematically shows tapered face plates for bridging screens wile eliminating the missing image parts at the corners according to another exemplary embodiment of the current invention.

FIGS. 9A and 9B schematically show an optical bridge having non-perpendicular aspect angle according to another exemplary embodiment of the current invention.

FIG. 10 schematically depict an optical bridge wherein the fiber in the faceplate are, curved and a method to produce such faceplate according to an exemplary embodiment of the current invention.

FIG. 10A schematically depicts a cross section of the optical bridge having curved fibers 1390 comprising an inward curved fibers prism 552 and outwards curved fibers prism 550.

FIGS. 10 to 10E schematically depicts steps of an exemplary method of production of an optical bridge having curved fibers according to an embodiment of the current invention.

FIG. 11 schematically depict a half optical bridge having piece-wise linear light guides according to another embodiment of the invention.

FIG. 12 schematically shows a cross-section of a tube made of fibers or mirrored plates, where the core, and therefore the layers, is configured as an extruded star according to another exemplary embodiment of the current invention.

FIG. 13 schematically depict an optical bridge having non-straight light guides according to yet another embodiment of the invention.

FIG. 14 schematically show cross sections in a LGS according to exemplary embodiments of the current invention.

FIG. 15 schematically depicts a half bridge wherein the light guides facing the viewer were polished at an angle substantially perpendicular to the light guide direction and a method for producing such half bridge according to an exemplary embodiment of the current invention.

FIGS. 16A-16D schematically show an exemplary preferred method of the production of the fiber optic face plate according to an embodiment of the current invention.

FIG. 17 schematically depicts a method of handling of a corner between screens according to an exemplary embodiment of the current invention.

FIG. 18 schematically depicts a cross section of an exemplary embodiment of a screen bridge, made of a flexible material according to the current invention.

FIGS. 19A and 19B schematically depicts a cross section of another exemplary embodiment of a screen bridge, made of a flexible material according to the current invention.

FIG. 20 schematically depicts another preferred embodiment of the current invention using solid, homogeneous objects made of clear optical.

FIG. 21 schematically depicts another embodiment of this invention, in which a half optical bridge is made of individual curved light guides.

FIG. 22 schematically depicts another preferred embodiment of the invention using a face plate made of double mirrored clear plates.

Attention is now called to FIG. 23 Showing another preferred embodiment of the invention, which is—in contrast to the previous embodiment—a subtractive method of production.

FIG. 23 schematically depicts another preferred embodiment of the invention using a block of machinable material.

### DETAILED DESCRIPTION OF THE DRAWINGS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In discussion of the various figures described herein below, like numbers refer to like parts.

The drawings are generally not to scale. Some optional parts were drawn using dashed lines.

For clarity, non-essential elements were omitted from some of the drawings.

As used herein, an element or step recited in the singular and proceeded with the word “a” or “an” should be understood as not excluding plural elements or steps, unless such exclusion is explicitly recited.

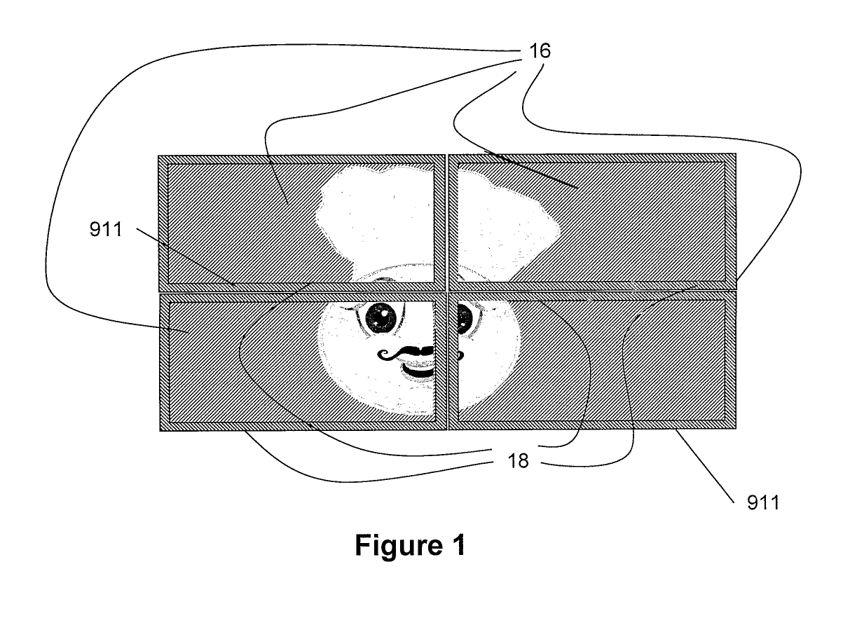

Attention is called to FIG. 1 schematically showing a 2-by-2 screens video wall, showing an image and having gaps according to methods used in the art.

FIG. 1, showing an image spread over four screens 16, interrupted by the bezels 911 around the screens 18 that do not display an image. This is the problem that this invention tries to solve. These gaps are unavoidable as commercially available Plasma and LCD displays have a protective case and some internal electronics around its display area, and cannot display an image end-to-end.

When combining multiple screens such as CRT, LCD or plasma video screens to form a large combined screen, the gaps, distracts from the appearance of the combined display and may cause image distortion and/or data loss.

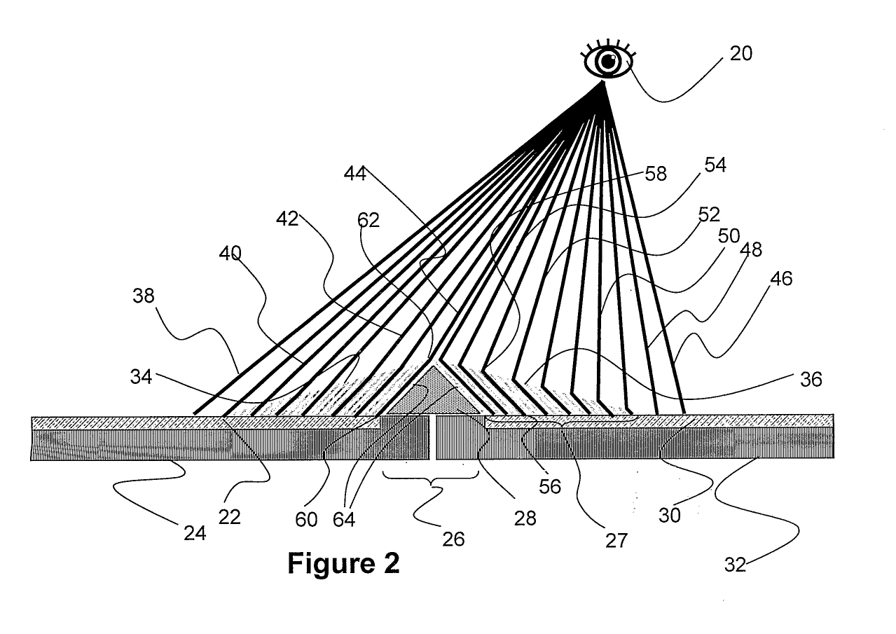

Attention is now called to FIG. 2, showing a preferred embodiment of the present invention, using an LGS faceplate.

Two, preferably digital screens 22 and 30 that belong to a video wall, such as CRT, LCD or plasma screens, are packaged in cases 24 and 32 that create an unavoidable gap 26 between them. Without using the current invention, a viewer 20 will see a segmented image.

According to an exemplary embodiment of the current invention, two prismatic fused fiber optic face-plate modules, for example as described in U.S. Pat. No. 5,465,315. issued Nov. 7, 1995 to Sakai et al, U.S. Pat. No. 5,572,034 issued Nov. 5, 1996 to Karellas, U.S. Pat. No. 5,615,294 issued Mar. 25, 1997 to Castonguay and are commercially available from Schott Inc, from Southbridge, Mass. USA

(http://www.schott.com/fiber optics/English/download/faceplates-11-04.pdf) are cut or polished into triangular prisms. The prisms 34 and 36 are attached to the screens 22 and 30 and are seen as triangles in this figure. One face of the prism is tangential to the screen, covering the “donor” stripe 27 of the screen that is to be expanded to cover an area that includes the stripe 27 and half of the gap 26. The most acute corner of the triangle is located at the inner end of the stripe 27. An obtuse corner of the triangle is located at the outer end of the stripe 27. The third corner of the triangle, which is also acute but has a larger angle than the first corner, is extended forward from the plane of the screens. The faceplate is composed of planar LGS's. The LGS's are parallel to the face of the prism that faces the opposite screen, so that each LGS extends from the input surface to the output surface of the faceplate. The other prismatic faceplate module is positioned symmetrically on the other screen, so that the extended corners of both prisms are tangent to each other. The fibers in each of the face plates are preferably oriented to be substantially vertical to the length of the prism and parallel to the inner faces 64 of the prisms.

It is a known property of a faceplate, that it shifts an image from its input plane to its output plane. A faceplate that is polished so that its input plane and its output plane are cutting the LGS's at different angles, changes the scale of the image between the input surface and the output surface, as the cross section of each LGS—and therefore the cross section of the plate—is different on the input and output surfaces.

This property is used in the present invention to linearly stretch the image.

The input plane, in this invention, is the face of the prism that is aligned with the screen. The output plane, in this invention is the face of the prism that extends between the two acute edges of the prism.

The same number of LGS's extend from the input surface to the output surface, therefore the portion of the image on the screen that is covered by the input surface of the prism (the donor area), will be viewable on the output surface of the prism, enlarged in one dimension to the full width of the output surface.

The free volume 28 between the two prisms can be used for securing the two prisms to their position, either by filling it with a filler material such as epoxy, or by gluing a prism of a solid support material to the bezels, and gluing the faceplate prisms to it.

As can be seen by the plurality of rays 38, 40, 42, 44, 46, 48,50, 52, 54—every point on the stripe 27 (and the symmetric stripe on the other screen) is seen at a point the is offset to bridge over the gap 26. By way of example, point 56 on the screen will be viewed at point 58 on the surface of the prism, and point 60 on screen 22 will be viewed at point 62 on the prism.

The distortion of the output image can be pre-compensated by software in preparation of the image intended for a video wall. When the image is sliced by a video wall processor into separate images for each screen, the portions of the image that are intended for the “recipient” stripes on the border between the screens is be pre-scaled down to fit into the “donor” stripes of the screens, so that they will be scaled up by the faceplate prisms into the correct scale.

It is stressed that fiber optics are given as one preferred embodiment of LGS, and a double mirrored acrylic or other transparent plate can be used to replace a layer of fiber optics.

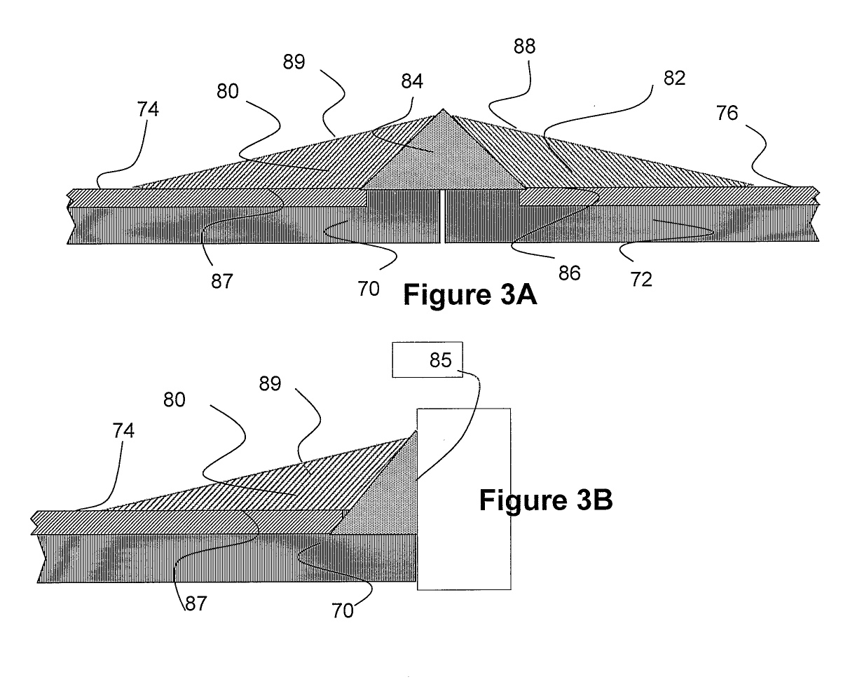

Attention is now called to FIG. 3A, showing an enlarged view of a cross section through two adjacent screens 74 and 76 packaged in their cases 70 and 72. The cases may be as close as touching each other, but the screens have an unavoidable gap between them.

Optionally a triangular support prism 84 made of a solid material such as a polymer (and shown in this cross section as a triangle) is glued to both cases, and to two prismatic faceplates 80 and 82. The faceplates are designed with their LGS's parallel to the face of the prism that is glued to the support 84 and perpendicular to the length of the prism. The surfaces 86 and 87 of the faceplate, that are touching the screen face, serve as the input surface of the faceplate. The surfaces 88 and 89 of the faceplates; that are facing the viewer; serve as the output surfaces of the faceplate. Every pixel in the. screens 70, 72 that is in contact with the input surfaces of the faceplates is projected out of the output surfaces of the faceplate. Due to the direction of the LGS's in the faceplate—the input surface is fully mapped into the output surface and the image is scaled up in a direction parallel to the screen surface, to bridge the gap between the two screens. The implementation of FIG. 3A is called, in this specification, “Optical Bridge”.

Attention is now called to FIG. 3B, showing half of the configuration of FIG. 3A—which is the implementation to be used, in a preferred embodiment of the present invention, at the edge of the video wall, to extend the coverage of the outer displays in the video wall over the bezel. This implementation, comprising one faceplate and a right angle prismatic support, will be called in this specification “half-optical-bridge”. The optical bridge of FIG. 3A can be viewed as two Half Optical Bridges, glued back to back.

In this embodiment, a right angle support structure 85 is optionally supporting the LGS optic prism 80.

According to another exemplary embodiment, each display is fitted with four half bridges ad seen in FIG. 3B, attached to its edges. In this embodiment, each screen is self contained, and there is no need to glue two displays to each other via the optical bridges. A defective screen may be replaced with a replacement screen. without having to remove anything but the defective screen. Additionally, any number of screens fitted with these half bridges may be combined to form a video wall without having to modify them.

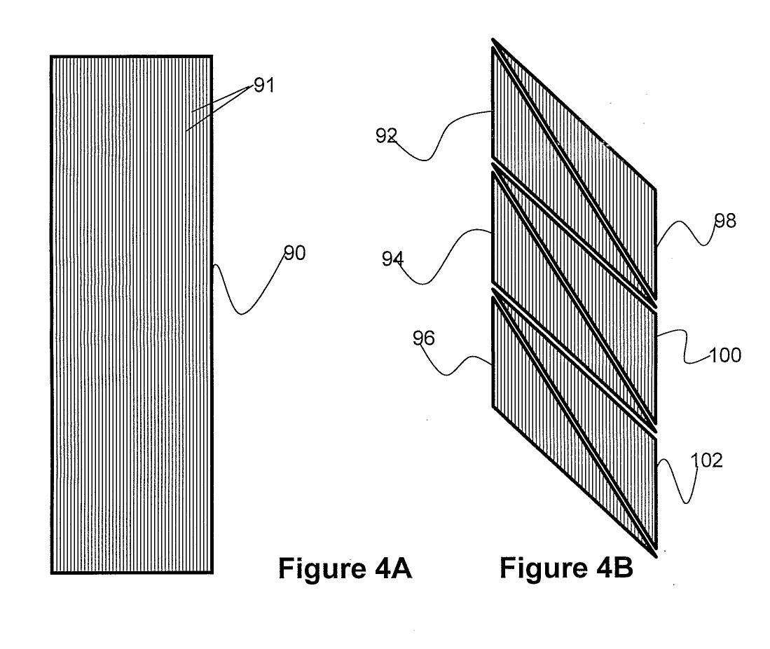

Attention is now called to FIGS. 4A and 4B, showing an economic way to cut suitable faceplates for the present invention from a rectangular block of fused, parallel optical. fibers. FIG. 4A shows top view of a rectangular block 90 of fused optical fibers. Preferably a fiber optic block with a pitch that is typically 120 DPI (Twice the resolution of a typical 60 DPI screen) such as is available from the Schott company mentioned hereinabove is used. The figure shows the block with the fibers 91 the vertical direction. The block has a thickness W that is not seen in this projection.

If the block is cut as shown in FIG. 4B, triangular prisms of the length of the cylinder are obtained. If each of the created the prisms 92, 94, 96, 98, 100 and 102 are polished along the cut surfaces, a prismatic faceplate is obtained. If two prismatic faceplates are oriented in the correct position, the configuration of a full optical bridge as seen in FIG. 3 is obtained.

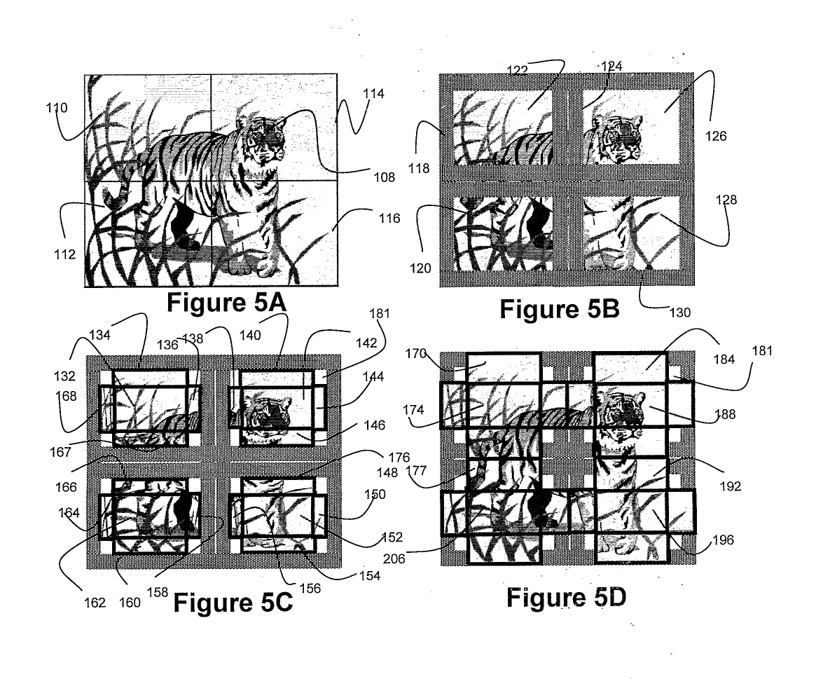

Attention is now called to FIG. 5A-5D, schematically showing the image pre-distortion that may be made, according to an exemplary embodiment of the current invention, so that the image—after scaling up by the faceplate—will be viewed as correct.

In FIG. 5A, an image 108 is to be displayed on four adjacent rectangular screens 110, 112, 114, 116.

However, as the screens have bezels that do not show an image, the image will be interrupted by the gaps, and will appear as in FIG. 5B, showing only four portions 120, 122, 126, 128 of the image, while other portions are blocked by the gaps such as 124 and 130.

It should be noted that the width of the gap in this figure is deliberately exaggerated far beyond reality, and the actual relative configuration has much narrower gaps.

As explained in FIG. 2 of the present invention, the peripheral stripes of each screen will be scaled outwards, to substantially join the image of the neighboring screen.

In order for the scaled up image to be correctly scaled, the stripe that is to be scaled up is preferably pre-scaled down, so that the stripe area will contain both graphic content of the stripe itself, and the graphic content of the gap area. This is explained in FIG. 5C. The portions 132, 142,152 and 162 of the original image will not be covered by an optical bridge, and will be viewed as is. They are not pre-scaled and are copied from the original image as is.

The portions 134, 140 will have to be extended upwards to cover the part of the gap above them. They will be covered by a half-optical bridge, as there is no screen above them. They are scaled down vertically, so that they contain the graphic content of their own are and the gap above them.

The portions 134, 140, 166, 148 will have to be extended upwards to cover the part of the gap above them. They will be covered by a half-optical bridge. They are scaled down vertically, so that they contain the graphic content of their own are and the gap above them.

The portions 167, 146, 160, 154 will have to be extended downwards to cover the part of the gap below them. They will be covered by a half-optical bridge. They are scaled down vertically, so that they contain the graphic content of their own are and the gap below them.

The portions 164, 168, 138, 156 will have to be extended leftwards to cover the part of the gap to their left. They will be covered by a half-optical bridge. They are scaled down horizontally, so that they contain the graphic content of their own are and the gap to their left.

The portions 136, 158, 144, 150 will have to be extended rightwards to cover the part of the gap to their right. They will be covered by a half-optical bridge. They are scaled down horizontally, so that they contain the graphic content of their own are and the gap to their right.

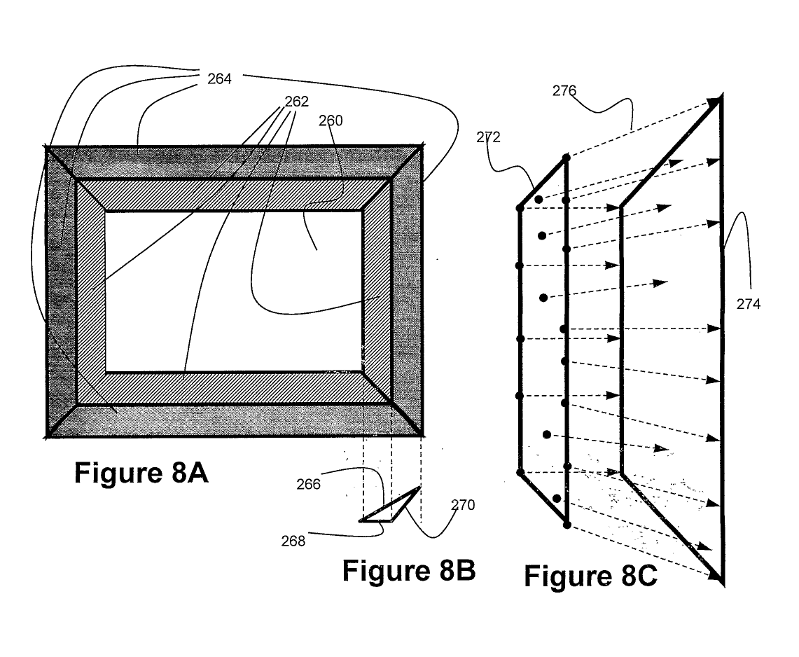

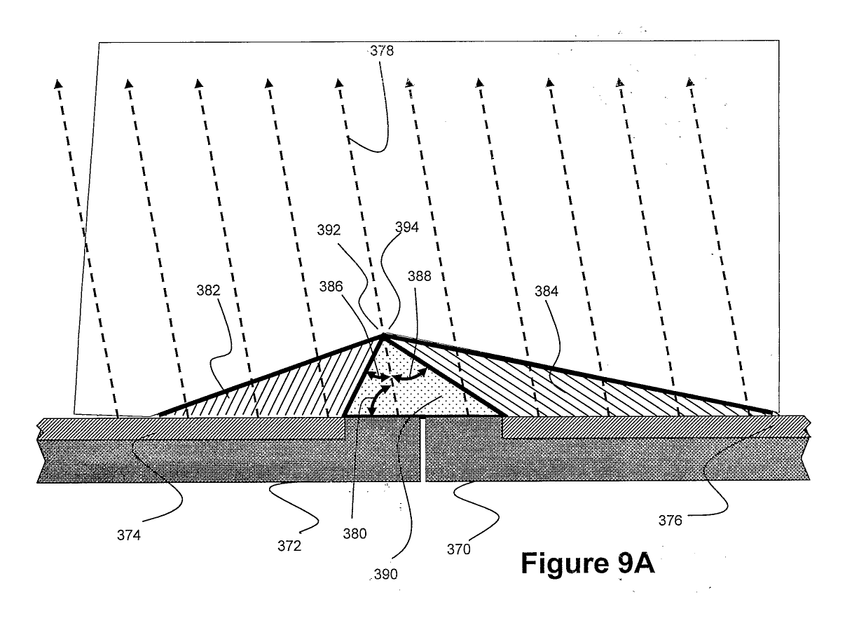

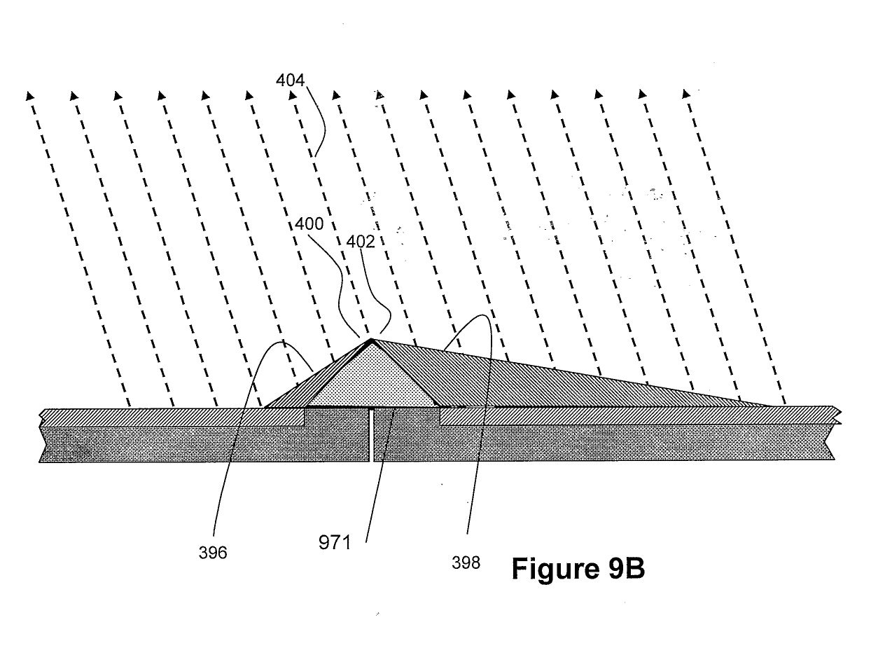

As can be seen in FIG. 5C, the corners of the screens (such as 181) are not bridged, and are not attended, in this embodiment. If the gap width between screens is 1 cm, then squares of 1 cm×1 cm at each corner of each screen will stay blank in the integrated image. These areas can be covered if the optical bridges are made trapezoidal to extend portions of the image to the corners. Such extension of this invention will be disclosed in FIGS. 8 and 9.

Attention is now called to FIG. 5D, showing the image as viewed when the half optical bridges are applied to the video wall.

Areas 174, 188, 196 and 206 are exact copies of areas 132, 142, 152 and 162 respectively.

Areas 170, 184, 192 and 177 are vertically scaled up copies of areas 134, 140, 1148 and 166 respectively, extending up to cover the gap above them.

Similarly, image in area at the bottom edges of each screen are vertically pre-shrieked and than stretched by the half bridge faceplate.

Similarly, image in area at the left, right edges of each screen are horizontally pre-shrieked and than stretched by the half bridge faceplate.

All four pairs of half optical bridges that are located back to back to each other, are unified as full optical bridges.

As can be seen in FIG. 5D—the original image has been correctly reconstructed, except for the corners.

It is stressed again, that the size of the corners in this figure is exaggerated for clarity. In atypical 2×2 screen wall, where the individual screen is 60 cm×80 cm and the gap between the screens is 1 cm, the “dead area” without the present invention is 1.5% while with the present invention it is 0.005%—an improvement by a factor of 300.

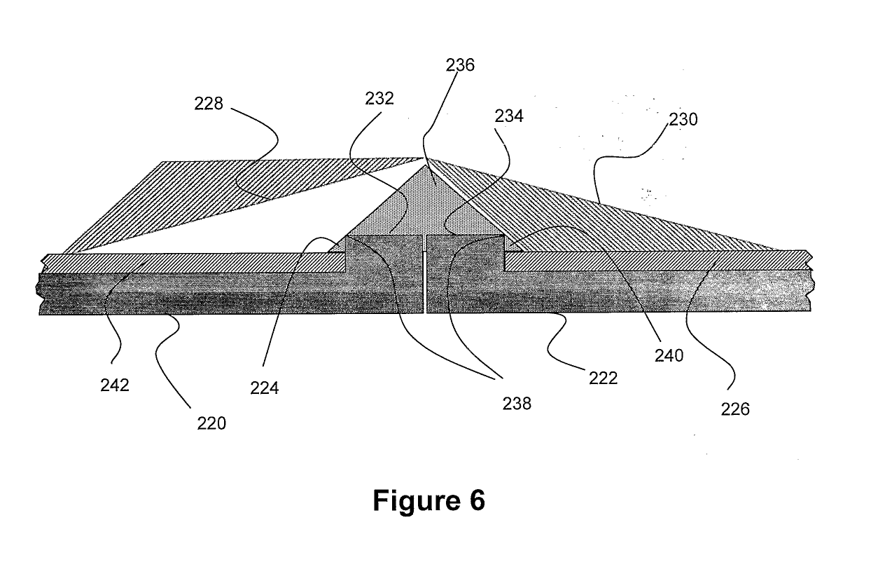

Attention is now called to FIG. 6, showing another preferred embodiment of the present invention, where the screens 242 and 226 are recessed into the cases 220 and 222, leaving the protrusions 232 and 234 extending out of the screen plain. This may be a design preference of the screen manufacturer, to protect the screen from scratches and other mechanical damages during transportation. This may also be a design constraint due to the technology of the screen. In such a case, the configurations of FIG. 3A will not enable tight coverage of the faceplate and the screen.

In the exemplary preferred embodiment of FIG. 6, the faceplates 228 and 230 are positioned slightly away from the seam between the cases into the area of the screen, so that the slopes of the faceplates are leaning on the corners 238 of the case. The empty areas 224 and 240 can be used for additional adhesive or support material, in addition to the main support 236.

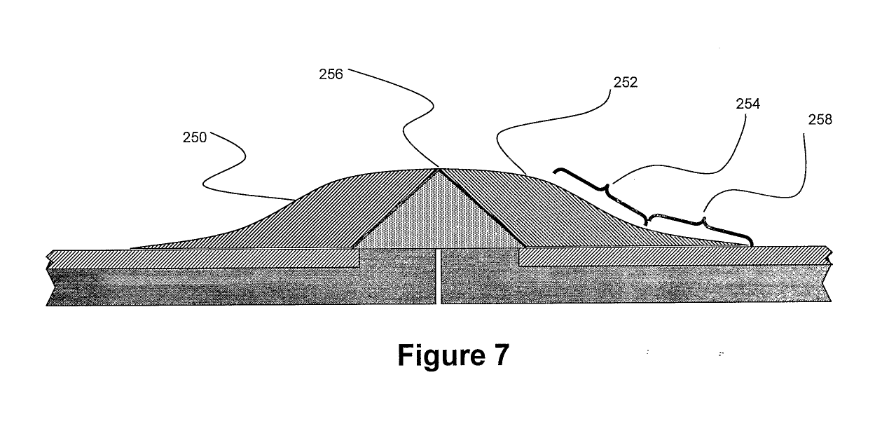

Attentions is now called to FIG. 7, showing a non-planar prismatic shape of the faceplates. This curved shape of the faceplates 250 and 252 eliminates the sharp angle between the faceplates at their meeting point 256 and makes the interface between the two screens seamless in terms of shadows and illumination angels. The pre-scaling of the image, by the software, is preferably non-linear, as the LGSs of the faceplate are cut at different angles along the curved slope. The area 254, for example, will expose the LGSs in a more slanted angle, meaning that the image of the screen at these points will be scaled up more than in the area 258, and the pre-scaling by the software will account for this.

It should be noted that the pre-conditioning of the image that is covered by the faceplate will pre-correct several types of distortion by the faceplate, so that the image seen on the faceplate will appear to the viewer similar to the image on the screen. If the faceplate absorbs some of the light and attenuates the image, the pre-correction will increase the intensity of the image. If the faceplate is not white and attenuates some of the colors more than others, the pre-correction will enhance that color. If the faceplates attenuate the light according to its thickness, the intensity correction will not be uniform and will compensate more in areas that are covered by a thicker layer of faceplate.

In a preferred embodiment of the invention, the system is calibrated by viewing the video wall after installation of the faceplates, and adjusting parameters in the video wall processor to obtain the best image. Some of the parameters that can be adjusted are the width of the faceplate margin, covered by the faceplate, the width of the portion of the image that is compressed into the margin, the non-linearity of the compression, and the color enhancement of the compressed image.

Attention is now called to FIG. 8A-8C, showing a preferred embodiment of the invention that covers the corners, eliminating the missing parts of the image such as 181 in FIG. 5D).

A screen 260 is framed by four half-optical bridges, as in previous embodiments. The faces of the optical bridge that are resting on the screen (the input surfaces) are marked as 262 and the faces of the optical bridges that are facing the viewer (the output surfaces) are marked as 264.

The triangular edges of the optical bridges are not cut perpendicular to the length of the prism, as in previous embodiments, but are slanted by typically 45°, as in picture frames, to meet each other and cover the corners between screens.

FIG. 8B shows a side view of one of the optical bridges, showing the input surface 268, the output surface 266 and the support surface 270 that is parallel to the. LGSs and is typically glued to the support that is glued to the case of the screen.

The fibers in this embodiment are not parallel to each other, but are rather fanning out and are mapping the input surface to the output surface, as is shown in FIG. 8C. This figure shows, side by side, the input surface 272 and the output surface 274. The arrows, such as arrow 276, show the mapping of points from the input surface to points in the output surface. The origin of each arrow (the circle) shows a typical point on the input surface, and the arrow head of each arrow shows the corresponding point on the output surface. Such fanning out can be achieved if the fibers are more compact on the input surface than they are on the output surface, using a filler material to fill the gaps between the fibers on the output surface.

The result is that the image seen by the viewer covers the corners that are not covered in previous embodiments.

Attention is now called to FIGS. 9A and 9B, showing an optical bridge having non perpendicular aspect angle according to another exemplary embodiment of the current invention.

The following preferred embodiment will be described in reference to the faceplate implementation of FIG. 2, but it should be clear that it is applicable to other embodiments.

The quality of the seaming, according to the present invention, depends on the deviation of the viewing aspect angle of the viewer from the normal to the faceplate output surface. The best image is delivered by the faceplate in an angle that is perpendicular to the surface.

The viewing angle on the outer surface and the acceptance angle of the input surface of an optic fiber are dependent on the properties of both the fiber core and clad. The numerical aperture of the fiber is higher when the difference between the refractive index of the fiber core and clad. This higher difference is typical of plastic optic fibers such that are used for automotive communication (e.g. such as ESKA, p-type series, made by Keiko corporation of Tokyo, Japan)

As the optical bridge of the present invention is typically tapered, having a very low elevation at both edges and a relatively higher elevation at the center, it cannot be planar, and therefore cannot have an output surface that is parallel to the screen.

In the embodiment of FIG. 2, the optical bridge is made of two planar faces, 34 and 36. A viewer that looks at the screen from a perpendicular angle, will see both output surfaces at equal obtuse angles. The optical bridge performs well at angles that are typically 30° from the perpendicular, giving a range of 60° of good performance. Yet, the best performance is when the viewer line of sight is perpendicular, because of the mini-max criteria—the maximum angle between the viewing direction and any of the two output surfaces is minimized when perpendicular.

When the typical viewing angle of the viewer is not perpendicular to the screen, the symmetric implementation of FIG. 2 is not optimal. This situation happens—for horizontal seams between screens—when the screen is hanging high above the audience, and the typical viewer sees the screen from below the horizon. The same problem happens, in vertical seams between screens, when a video wall is placed in a TV studio behind the announcer, and the long-shot camera is located diagonally from the video wall. Additionally, in very large video walls, some end of the wall may be viewed at angles substantially different than the normal even for centrally located viewer.

This problem is solved by the exemplary preferred embodiment of FIG. 9. Two cases 370 and 372 contain two co-planar screens 374 and 376. The preferred viewing angle happens to be 380, between the direction of the viewer 378 and the screen.

Two faceplates 382 and 384 are applied to the screens, with the fibers parallel to the faces of an optional support prism 390. The angles of the two prisms and direction of the fibers in the prisms are not equal, and each prism has to be manufactured to suit the angle 380 that may change from one installation to the other.

The direction of the fibers and of the support prism is made so that the two angles 386 and 388 between the two support faces and the direction of viewing are preferably substantially equal. This causes the viewing angles of the fibers in both faceplates to be even, from the relevant viewing angle.

The output surfaces of the two faceplates are also made to have equal angles 392 and 394 with the viewing direction.

In this embodiment, the fibers and the output surfaces of both faceplates are seen, from the relevant viewing angle, at the same angle and the maximum angle between the viewing angle and the output surfaces is minimized, producing the best quality of stitching. The stitching from other viewing directions will be good, but not optimal.

Attention is now called to FIG. 9B, showing a preferred embodiment of the current invention having a non-symmetric optical bridge using fibers of the same direction in both faceplates.

The main disadvantage of the embodiment of FIG. 9A is that a different type of faceplate has to be manufactured for each viewing angle.

This problem is partially solved in the embodiment of FIG. 9B wherein both faceplates 396 and 398 have the same angle of fibers, and therefore the support prism 971 between them is symmetrical. The output surfaces are slanted in different angles, so that they preferably have substantially equal angles 400 and 402 with the viewing angle 404. Clearly, in this embodiment, the two faceplates have very different donor area widths.

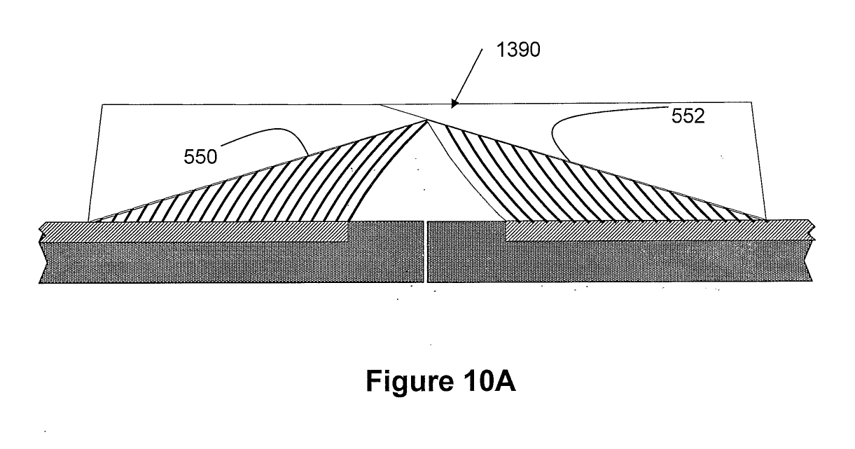

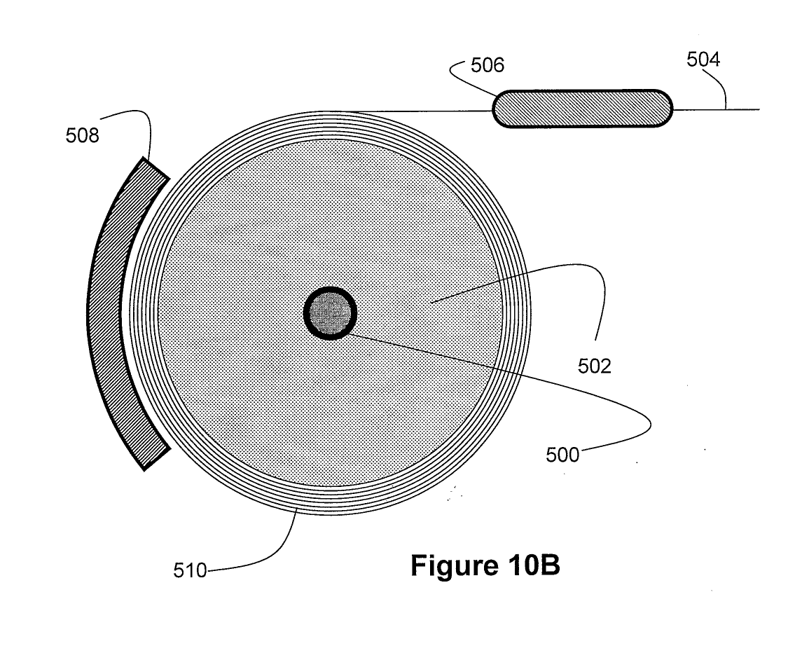

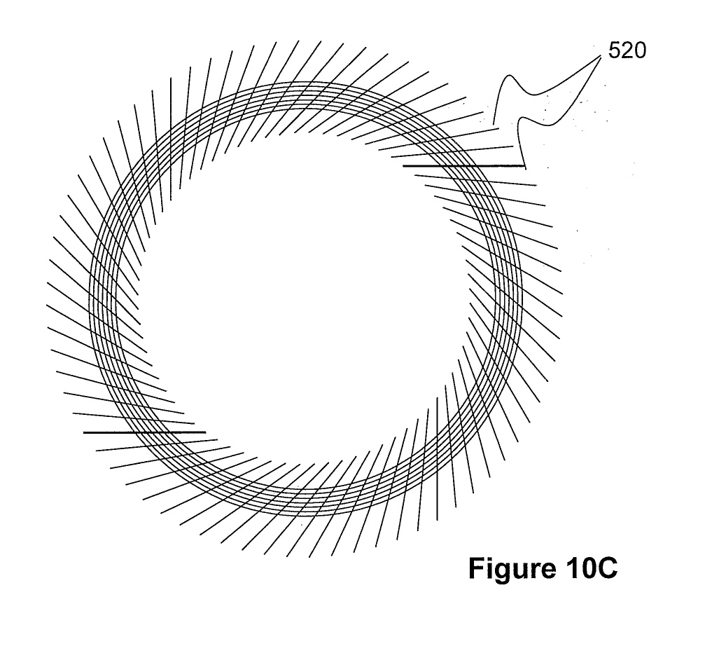

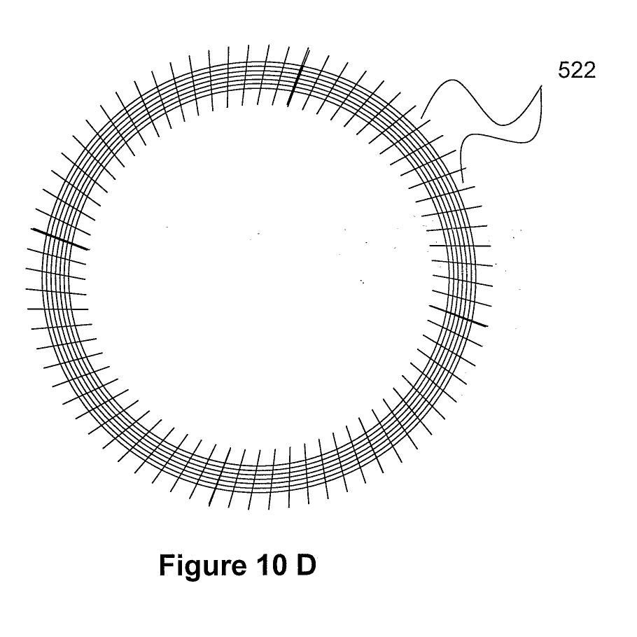

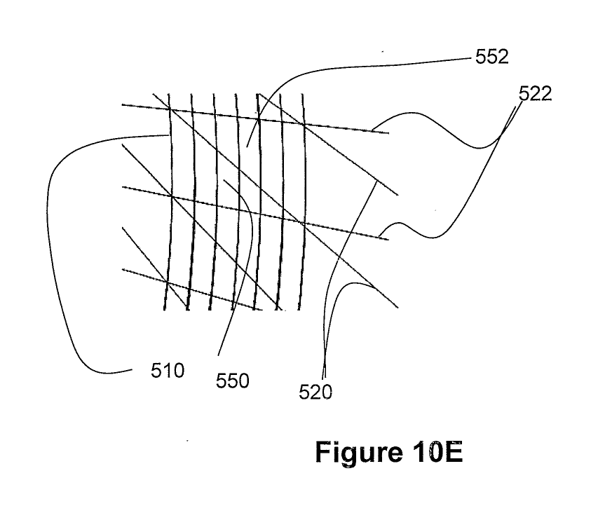

FIG. 10 schematically depict an optical bridge wherein the LGS in the faceplate are curved and a method to produce such faceplate according to an exemplary embodiment of the current invention.

FIG. 10A schematically depicts a cross section of the optical bridge having, curved LGSs 1390 comprising an inward curved LGSs prism 552 and outwards curved LGSs prism 550. If the segments cut from the cylinder are implemented in this embodiment, than all the screen bridges made of a given cylinder are uniform in shape and properties. Alternatively, the vendor can separate the convex half-bridges and the concave half bridges, and match them in uniform pairs.

FIG. 10B to 10E schematically depicts steps of an exemplary method of production of an optical bridge having curved LGSs according to an embodiment of the current invention.

FIG. 10B schematically depicts a method for producing a fused LGS core with curved LGSs.

Fiber 504 is coated with glue when it traverses coater 506. The glue coated fiber is wound on a spindle 502 which rotates counterclockwise about its axis 500 to form a multilayer fiber core 510, preferably one layer after the other.

Optionally, curing device 508 assist in curing the glue, for example curing device 508 may be a UV lamp for curing UV activated resin, alternatively, curing device 508 may be a heater for heating the glue or evaporating the solvent in the glue.

FIG. 10C schematically depicts highly slanted cuts 520 made in the core 510. Highly slanted cuts 520 may be made for example with a circular blade disk saw while the core is on the spindle 502 or after the core have been removed.

FIG. 10D schematically depicts perpendicular or less slanted cuts 522 made in the core 510. Cuts 520 may be made for example with a circular blade disk saw while the core is on the spindle 502 or after the core have been removed.

FIG. 10E schematically depicts the production of inward curved fibers prism 552 and outwards curved fibers prism 550 from core 510 by cutting the core 510 along the highly slanted cuts 520 and the perpendicular or less slanted cuts 522.

In an exemplary embodiment, the dimensions may be approximately: the diameter of the core is 80 cm; the length of the cylinder is 120 cm; the LGS is wrapped to a thickness of about 15 mm.

The cylindrical core is cut, parallel to its axis like this. The pieces do not fall apart as they are glued to the spindle. This is done by cutting and indexing the cylinder about its axis. Then the cylinder is cut again, parallel to its axis, at the same angular pitch, at a different angle. Now the rods are detached from the core.

The fact that one of the inner faces is convex and the other is concave may cause different optical properties, and can be compensated by calibration by the software.

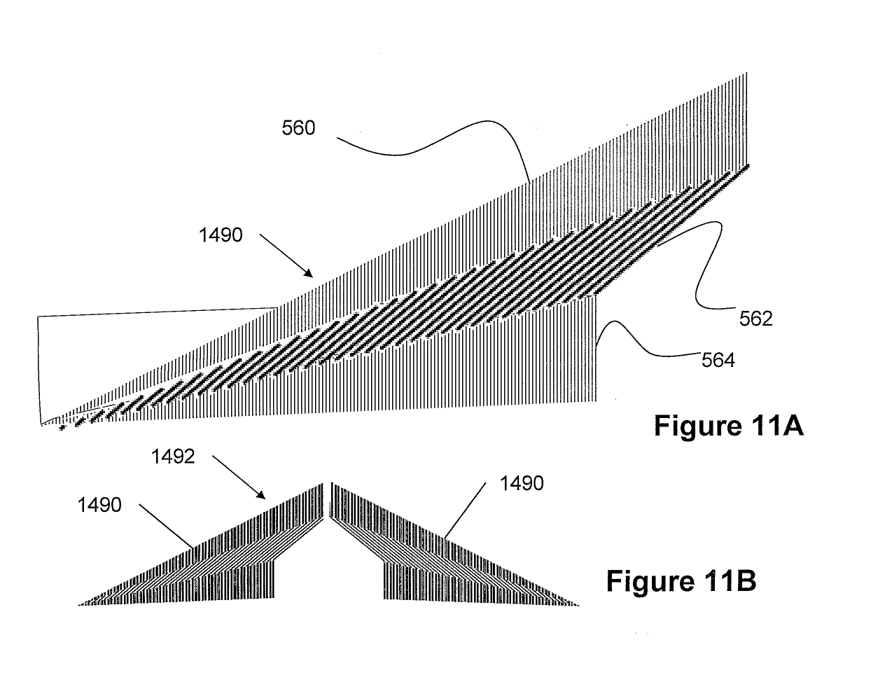

FIG. 11 schematically depict faceplate having non-straight LGSs according to another embodiment of the invention.

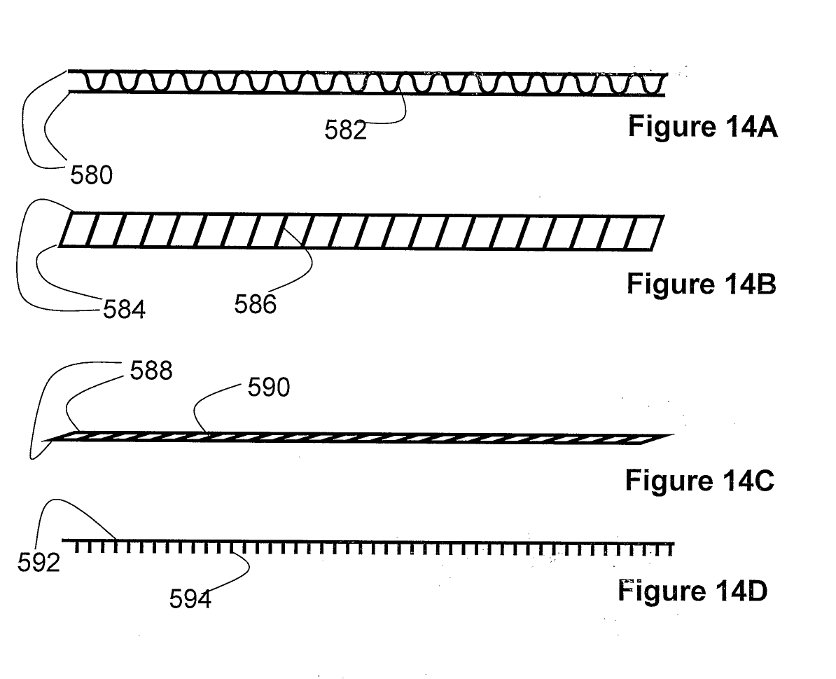

FIG. 11A schematically depict a half bridge with zigzag LGSs 1490 comprises two segments of LGSs 564 and 560 which are substantially perpendicular to the face of the screen (not shown in FIG. 14); and a segment 562 wherein the LGSs are slanted in respect to the face of the screen.

FIG. 11B schematically depict a full bridge with zigzag LGSs 1492 comprises two half bridge with zigzag LGSs 1490 symmetrically situated.

In some embodiments of the invention the piece-wise half bridge with zigzag LGSs 1490 is manufactured from joining three segments of straight LGSs.

In other embodiments, the light guides are bent to shape and than joined.

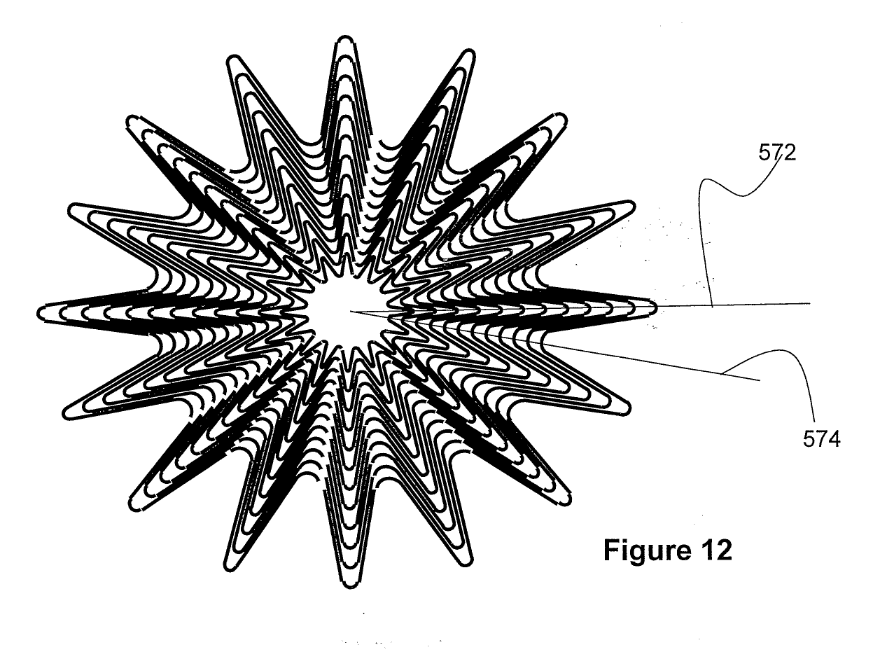

Attention is now called to FIG. 12. One disadvantage in the embodiment of FIG. 11A is the sharp change of angle in the interface between prisms. Such sharp angle is known to attenuate the light, causing the system to lose brightness. Another disadvantage of the configuration of FIG. 11A is that it requires accurate assembly and gluing. Some of these disadvantages are solved in the configuration illustrated in FIG. 12.

FIG. 12 schematically shows a cross-section of a tube made of LGS's where the core, and therefore the layers, are configured as an extruded star according to another exemplary embodiment of the current invention.

If the LSG's are wound and glued around the core in this way the glue serves as a filler, and is applied so that the separation between layers in the concave angles of the star is small (small amount of filler) and the separation between the layers in the convex angles of the star is large (large amount of filler). This configuration preserves the star shape of the tube. The resulting tube is then cut along radial planes 572 and 574, the part that is created acts as a half-bridge, where both input surface and output surface are perpendicular to the screen, and there is no sharp interface along the light path. In fact, the light that enters one of the LSG's in the input surface must stay within this same LSG until it reaches the output surface. The scaling of the image between the input surface and the output surface are achieved by varying the density of the LSG's between the input and output surfaces. The production of an extruded star prism can be done by winding a flexible LGS around the core, pressing it into the concave areas of the core, and curing an adhesive to keep the new layer on top of the previous layer. Clearly, the number of prisms that can be cut from an extruded star equals to twice the number of corners of the star.

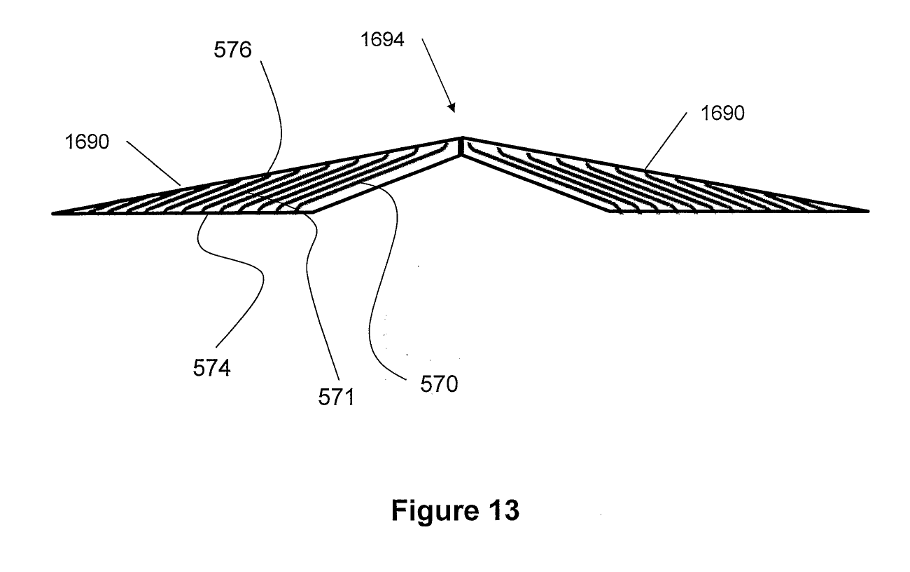

FIG. 13 shows how a prism cut from the tube of FIG. 12 can be configured to become a half screen bridge. Two prisms such as 570 are configured as a screen bridge. Each. LGS, such as 571, has a perpendicular input 574 and output 576 ends. The pitch of the LGS's at the input surface 574 is smaller than the pitch of the LGS's at the output surface 576. This can be achieved by controlling the amount of glue between the LGS's during winding of the tube in FIG. 12. This difference gives the scaling up effect of the screen bridge.

FIG. 13 schematically depict faceplate having non-straight LGSs according to yet another embodiment of the invention.

FIG. 13 shows a full bridge with zigzag LGSs 1694 comprises two half bridge with zigzag LGSs 1690 symmetrically situated.

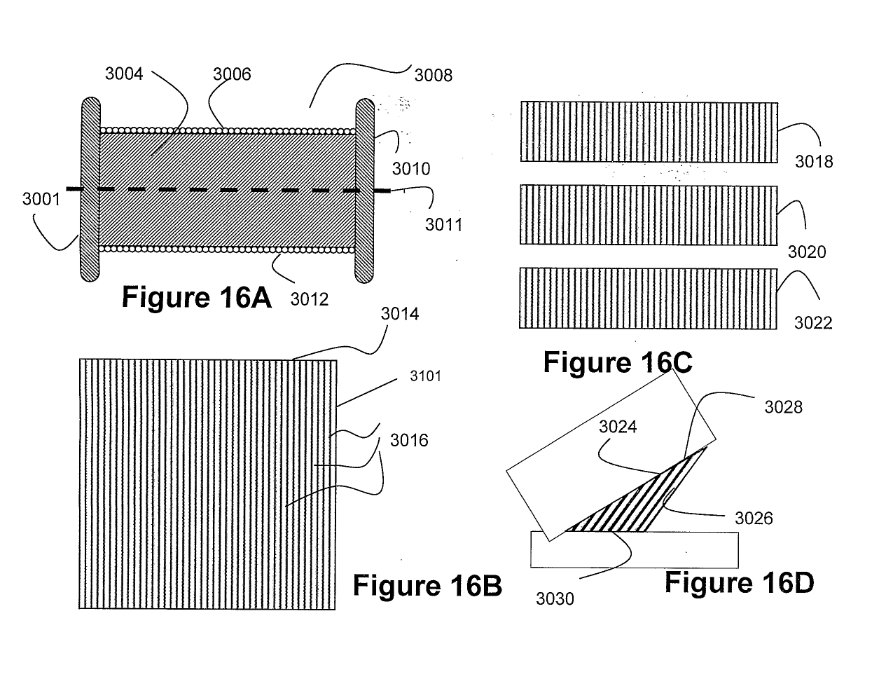

Each half bridge with zigzag LGSs 1690 comprises two segments of LGSs 576 and 560 which are curved and their ends substantially perpendicular to the face of the screen (not shown in FIG. 16); and a segment 570 wherein the LGSs are substantially straight and slanted in respect to the face of the screen.

Attention is now called to FIG. 14A, showing a cross section in a LGS of a preferred embodiment. The walls 580 and the wave shaped rib 582 are made of a thin flexible material such as PVC. The whole structure is coated with reflective material. The LGS's are glued to each other so that the direction of the tunnels is leading the image from the input surface to the output surface. A light beam that enters any of the “tunnels” within the LGS at the input surface will be reflected from the walls of the tunnel and will stay within the tunnel until it reaches the output surface.

Attention is now called to FIG. 14B, showing another cross section of another preferred embodiment. In this embodiment, the walls 584 are spaced by ribs 586. The tunnels in this embodiment are relatively wide, enabling a coating process to take place. After coating, the structure can be squeezed as shown in FIG. 14C, causing walls 588 to come close to each other, thus making the image resolution higher. The structures are glued to each other in the squeezed state.

Attention is finally called to FIG. 14D, showing yet another. configuration 592 of an LGS. This comb shaped embodiment is very easy to coat, as the coating fluid has open access to all walls and ribs 594. When structures of this embodiment are glued to each other, the wall of one layer closes the tunnels of the next layer as the ribs 594 come in contact with the wall of the next layer. The result is closed tunnels that conduct light from the input to the output surface.

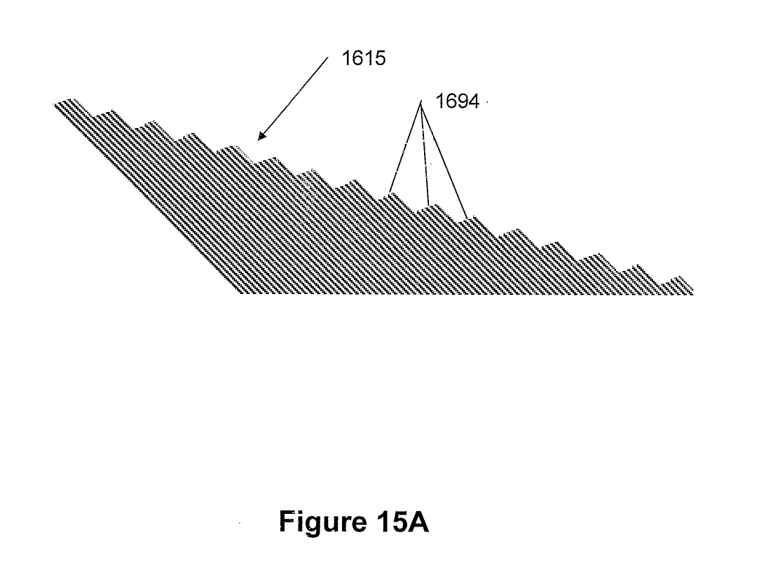

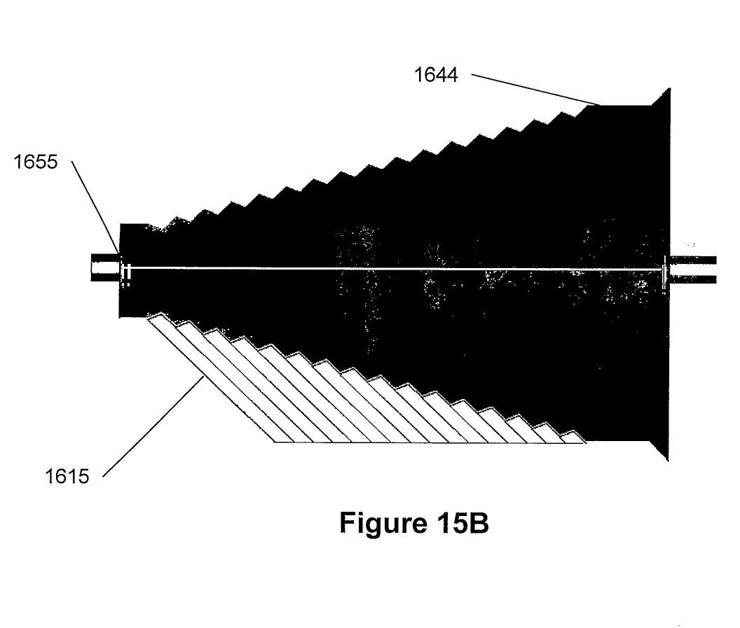

FIG. 15 schematically depicts a half bridge wherein the LGS's ends facing the viewer were polished at an angle substantially perpendicular to the LGS axis and a method for producing such half bridge according to an exemplary embodiment of the current invention.

FIG. 15A schematically depicts a half bridge 1615 wherein the LGS's ends facing the viewer were polished at an angle substantially perpendicular to the LGS axis forming stair case structure 1694.

Polishing the LGS at an angle substantially perpendicular to the LGS axis may enhance light output from the LGSs.

Alternatively, other angles may be used which may direct the light from the LGSs towards the viewer.

FIG. 15B schematically depicts method of producing a half bridge wherein the LGS's ends facing the viewer were polished at an angle substantially perpendicular to the LGS axis.

Half bridge 1615 with LGS's ends facing the viewer polished at an angle substantially perpendicular to the LGS axis is formed by polishing a LGS faceplate, for example as depicted in FIG. 2; 4B, 6; 7; 9A; or 9B, with a grinding wheel 1644 rotating about its axis 1655, wherein the grinding wheel is constructed to conform the desired staircase shape 1694.

Attention is now called to FIGS. 16A-16D showing an exemplary preferred method of the production of the LGS optic face plate according to an embodiment of the current invention.

FIG. 16A shows a cross section of a spool 3008 made of a cylindrical core 3004 and two circular edge plates 3001 and 3010, rotated around its axis 3011. A is wound around the core in one layer 3006, 3012. When winding a fiber in one layer, it is easy to get it well aligned where each winding is tangent to its neighbors. The fiber is glued to its neighbors by applying glue to the fiber whether before or after the winding, and curing the glue after the winding.

FIG. 16B shows a single layer 3101 of fibers 3016, glued to each other, after the layer has been cut along a line 3014 parallel to the axis and stripped from the spool.

FIG. 16C shows the layer 3101 cut to stripes 3018, 3020, 3022 the thickness of which is a single fiber, and the length of which is the length of the stripes to be produced in the process.

FIG. 16D shows a side view of a ready optical bridge 3028, where the stripes, (for example strip 3026) have been glued to each other and then cut along planes 3024 and 3030, forming an input surface 3030 and an output surface 3024.

This method of production ensures clean and parallel fibers and avoids winding problems that are typical to multi-winding spooling.

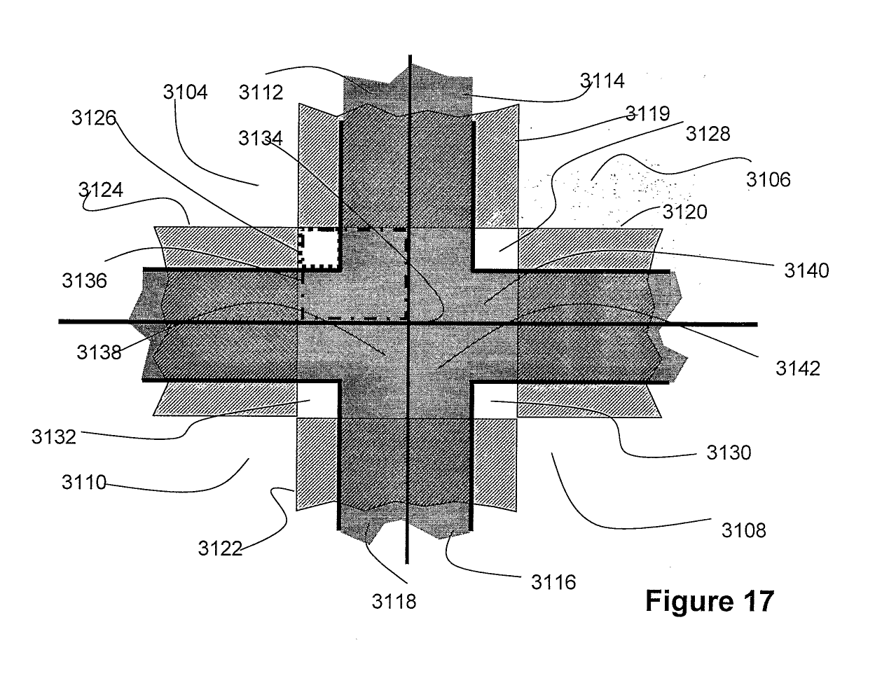

Attention is now called to FIG. 17, showing the handling of a corner between screens, in one preferred embodiment.

Four screens, for example LCD screens, (partially shown as 3104, 3106, 3108, and 3110) are protected by bezels 3112, 3114, 3116, and 3118 that are meeting each other at the corner point 3134.

Optical bridges as described in this application, partially shown as 3119, 3120, 3122, and 3124, are seaming the gaps between the pairs of screens. The intersection of the bridges that cover a part of the display leaves a square around the corner 3134 that is not covered by a bridge, and exposes the bezels of the screens.

An optical plug (not shown) is covering this square, closing the gap between the four bridges. The plug is designed to collect light from its corners (3126, 3128, 3130, 3132) that are exposed to the active part of the screen, and to release the light emerging from the input corner on the near quarter of the plug, so that the light collected at the input surface in 3126 is coming out of the plug in the area 3136 (for clarity areas 3126 and 3136 were marked with black dashed line and white dashed line respectively). Similarly, the light from 3128 comes out at 3140, from 3130 to 3142 and from 3132 to 3138. The guidance of the light from the input areas to the output areas can be done with tapered fibers, as offered in the Edmund Optics (Edmund Optics Inc. Barrington, N.J., USA) catalog under “Fiber optic tapers”, or can be reflected via planar optical mirrors that separate the plug into the four squares.

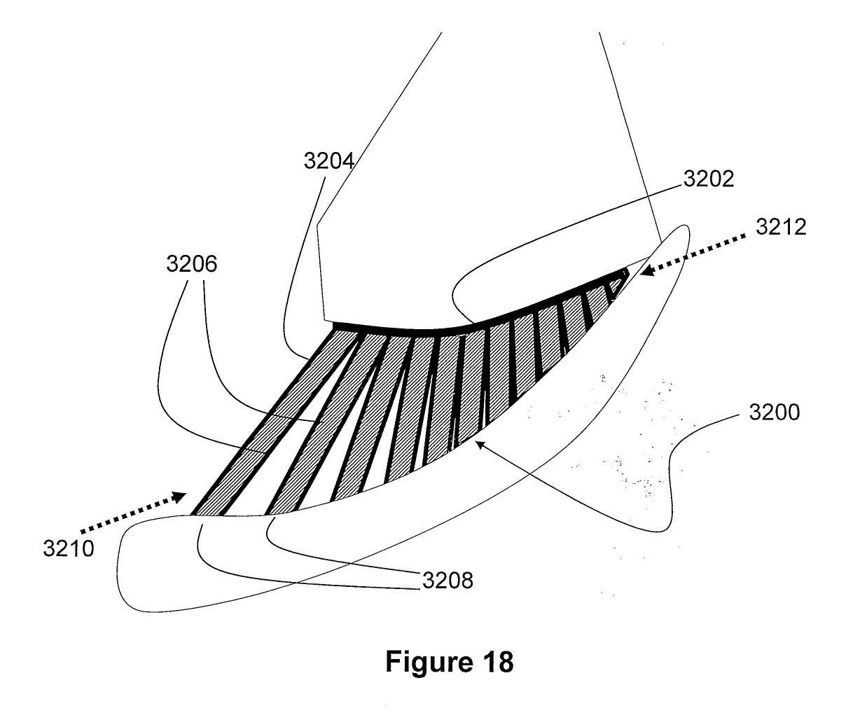

Attention is now called to FIG. 18, showing a cross section of an exemplary embodiment of a optical bridge, made of a flexible material according to the current invention.

A comb shaped structure 3200 made of a flexible material such as clear silicon, is produced for example by extrusion, or by casting, or by forging so that its uniform cross section resembles a shape of a comb, or a rake, as illustrated FIG. 18. (In this application, the term “extrude” is used as a generic name for processes of crating a shaped solid object out of a fluid thermoplastic material, such as molding, casting, forging and extruding). The strips 3208, seen in figure as rectangles, are connected to each other by a flexible connecting member 3202. In its natural shape, without forces applied to it, the structure 3200 is astride, as in the figure. By applying a small compressing force, in the directions 3210 and 3212, the structure is closed and the stripes 3208 become tangential to each other along their full length. The edges 3208 of the strips can be designed to merge into one slanted plane, or can be shaped to create a non-planar surface, such as a lenticular lens giving the object desired optical properties of directing the light into and out of the object—this will be determined by the shape and the length of each stripe, and this is determined by the shape of the extrusion nozzle and can be designed to produce the desired shape. In the same manner, the outer side of the connecting member, that does not face the teeth of the comb, can be shaped to be a flat surface (as is illustrated) or can be designed as a lenticular lens to give that surface desired optical properties in collecting light beams into the object, or propagating them out of the surface. In the compressed position, the connecting membrane 3202 becomes essentially planar, and the whole structure assumes the shape of a triangular prism.

When in its astride shape, the structure 3200 is preferably coated by a reflective coating 3206, such as a thin (typically 8 micron) layer of aluminum. Coating materials with a reflective layer is well known in the art and is practiced by mirror manufacturers and by coated sheet manufacturers, such as CoatLab, Hanita, Israel. The structure is then optionally coated with a thin layer of glue that preserves it in the compressed shape.

The outer side of the connecting member 3203, and the ends 3208 of the stripes, are preferably not coated, or—alternatively—are polished to remove the coating. The coated areas are marked in his figure by a thicker line 3206.

When the structure is compressed to a prism, it becomes a half-optical bridge, comprising a single transparent body, interweaved by parallel, and double-sided reflective surfaces. The connecting member 3202 typically becomes the input surface, the ends 3208 of the stripes become the output surface, and the edge of the largest stripe 3204 becomes the support face that will be glued to the base—as shown in FIG. 2 and in other figures above.

It should be noted that index matching jell or glue may be used to enhance optical coupling of light emitted from the screen into the optical structures of a bridge in some or all the abovementioned embodiments.

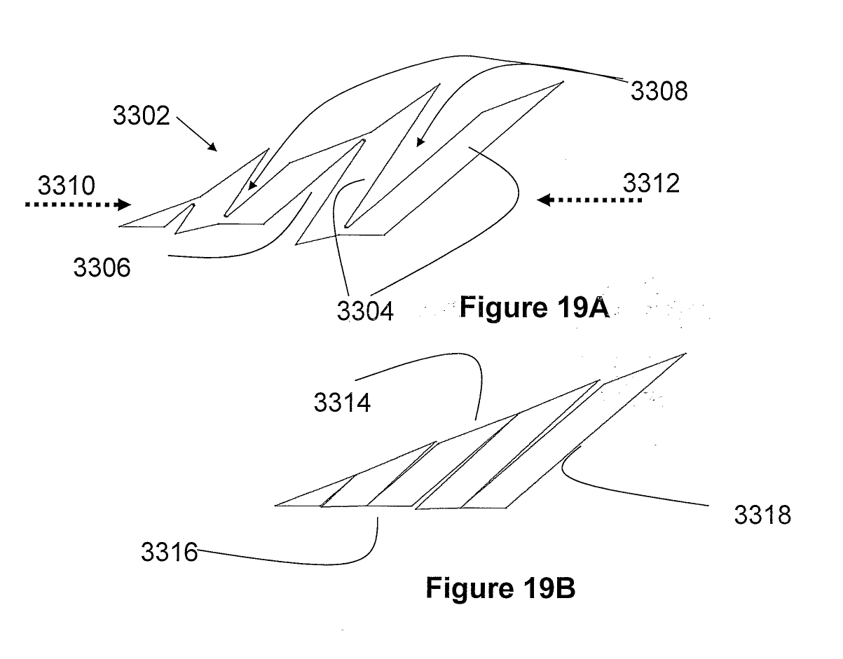

Attention is now called to FIGS. 19A and 19B showing another embodiment made of a flexible material.

FIG. 19A shows a side view 3302 of an extruded object made of a flexible and clear material such as silicon. The object is made of a group of rectangular ribs 3304, connected to each other by connecting members, where the odd connectors are at the bottoms of the ribs and the even connectors are at the tops of the ribs. The ribs are slightly separated open from each other, leaving places 3306 and 3308 for a fluid to flow and coat the faces of the ribs with a reflective coating. Following coating, the structure is compressed along directions 3310 and 3312 to close the spaces between the ribs and become a triangular prism, as shown in FIG. 19B. This prism can be used as a half bridge, with an input surface 3316, an output surface 3314, and a support surface 3318.

Preferably, reflective coating is removed from input surface 3316, and output surface 3314

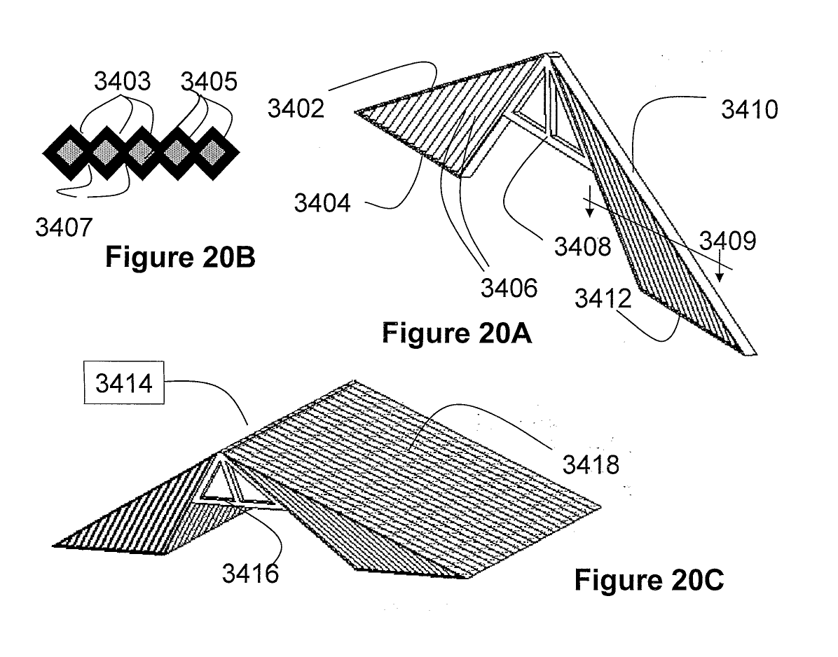

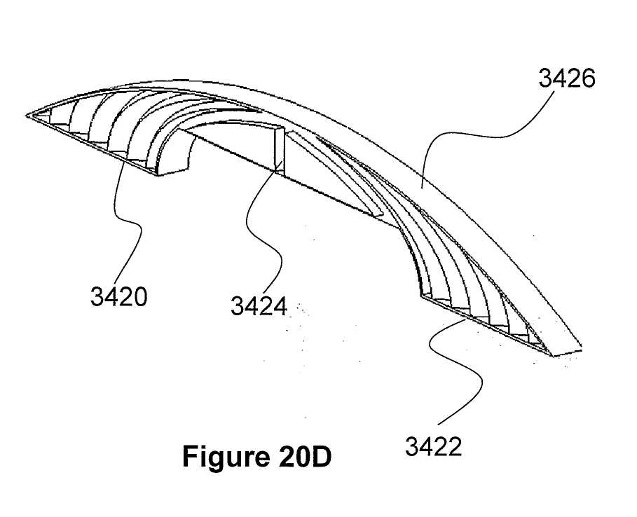

Attention is now called to FIG. 20A showing another preferred embodiment of the current invention. A solid, homogeneous object made of clear optical material such as acrylic or polycarbonate, by molding, casting or machining, serves as one out of a plurality of slices in an optical bridge.

The object is made of two triangular wings, each of which is an LGS projecting a line image from an input line 3404 and 3412 to an output line 3402 and 3410. The optical object may or may not be coated, after or during fabrication, by a light reflecting material such as aluminum or by a clad material having a lower refractive index then the object itself. The two wings are connected by a support triangle 3408.

FIG. 20B shows a partial vertical cross section 3409 through a wing.

The object is ribbed 3405 and is shown here coated by a reflective material 3403. The ribs are shown interconnected 3407 but the connection between the ribs is narrow and light making its way along the rib (perpendicular to the drawing) is likely to be reflected back into the rib and rarely leak from one rib to another, also avoiding connectivity between ribs is possible as the ribs may connect only at the input, output surpasses, both or intermediately.

FIG. 20C shows a multiplicity of objects 3414 such as described in FIG. 20A, attached to each other to create a prism 3418 where the support triangles 3416 become the support structure that is glued to the bezel of the display.

As the mirror coating is reflective on both sides, the air passages between the ribs can become square lights guides in themselves, where two faces of the light guide are taken from one slice, and the other two faces are taken from the contiguous slice—doubling the resolution and amount of light projected from the input surface to the output surface. Designs featuring favorable resection for an “internal light guide” or an “external light guide” are possible as well.

Attention is now called to FIG. 20D showing an alternative embodiment of the slice of FIG. 20A, wherein the light guides 2420 and 2422 are perpendicular to the input line and are curved to make a smooth output surface 3426. The support area 3424 is curved and not triangular as in FIG. 20A. The light guides may curve in a way that points exiting light to favorable directions, likely to be perpendicular to the screen at exit and each light guide may end in a curved “lens” like shape, spherical or otherwise to correct light distribution to desired directions.

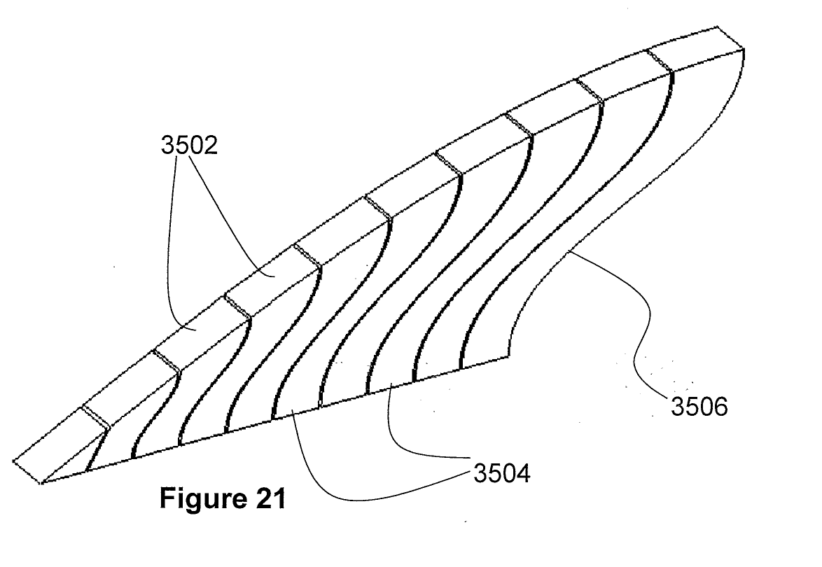

Attention is now called to FIG. 21 showing another embodiment of this invention, in which a half optical bridge is made of individual curved light guides 3506, fabricated by casting, molding or machining. The light guides are designed to next each other as shown. The light guides may or may be not individually coated by a mirroring coating such as aluminum or by clad as above, and then machined to leave the bottom and top surfaces clear of coating. When nested into each other as shown in the drawing, they define an input line 3504 and an output line 3502 and project light from the input line to the output line. The nested object can act as a wing in the configuration of FIG. 20, and multiple wings can be stacked to become an optical bridge.

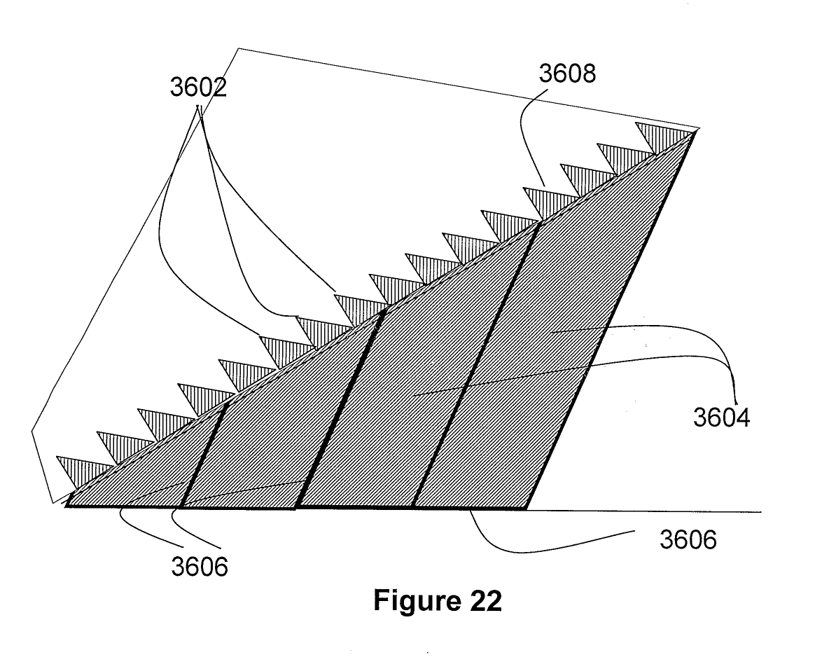

Attention is now called to FIG. 22 showing another preferred embodiment of the invention. A face plate made of double mirrored clear plates. 3604 is shaped as a triangular prismatic optical bridge. The reflective layers 3606 between the plates forces the light coming from the input surface 3606 to go within the plate and come out of the output surface 3608. An optical steering layer made of small triangular ridges 3602 is glued to the output surface. This layer, available from 3M company as “light management film” of the “Vikuiiti” family of products can be glued to the output surface or can be fabricated as part of the plate.

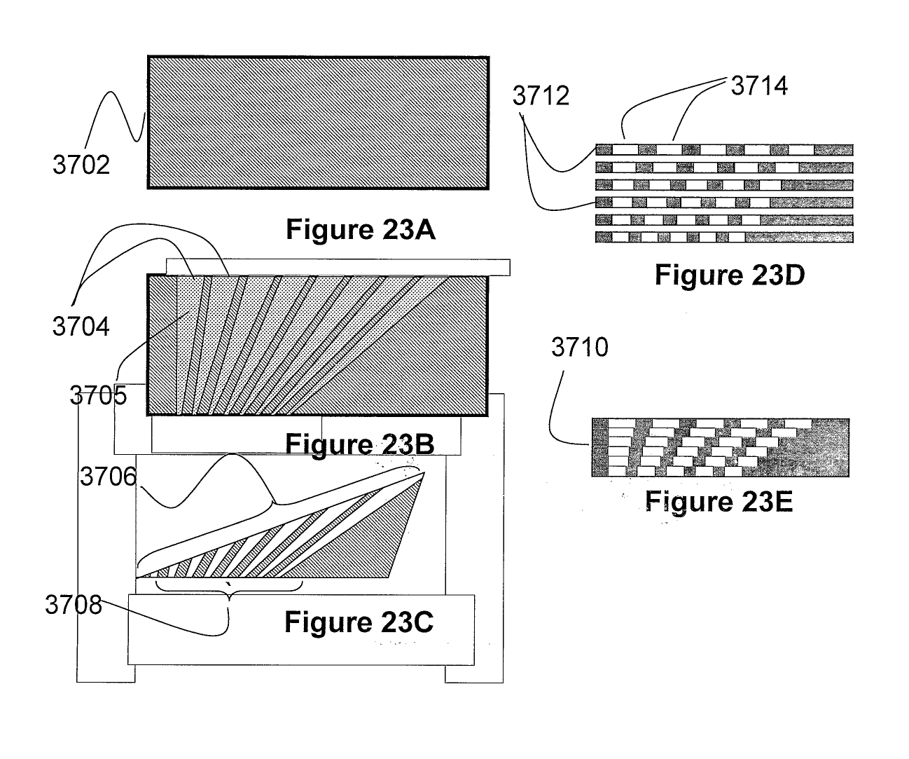

Attention is now called to FIG. 23 Showing another preferred embodiment of the invention, which is—in contrast to the previous embodiment—a subtractive method of production.

FIG. 23A shows a block of machinable material 3702 such as aluminum or PVC. The block is drilled by a method known in the art such as mechanical drilling, laser drilling or water jet drilling. FIG. 23B shows the shape, orientation and direction of the holes 3704. The holes are made in conical shape, are srilled diagonally, and are oriented so that their density at the bottom of the block is higher than at the top of the block. The holes are then coated with a reflective materials, such as aluminum. Following the coating, the holes are filled with a light guiding material 3705 of proper optical properties, such as PMMA. The block is then cut (FIG. 23C) to the shape of triangular, prism and becomes an optical bridge, so that the area of the bottoms of the holes 3708 is the input surface of the optical bridge, and the area of the tops of the holes 3706 is the output surface of the optical bridge.

FIG. 23D shows an alternative method of producing the “subtractive” optical bridge. A plurality of sheets of material 3712 such as aluminum or PVC are drilled with a gird of holes 3714, so that the pitch between the holes and the diameter of the holes in each sheet are slightly smaller than in the previous sheet. The sheets are then placed on top of each other (FIG. 23E) to become a solid block with diagonal conical holes. The block is them processed as described in FIGS. 23B and 23C.

The result is an optical bridge that can function as described hereinabove in this application.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed:

1. A composite video wall displaying a substantially undistorted and gapless image, comprising:
plurality of adjacent digital graphic displays, each comprising a net image displaying area and a non image displaying bezel; and
at least one optical bridge attached to at least one of said displays, covering only a portion of said net image displaying area and a portion of said bezel, wherein the input surface of said optical bridge covers said portion of said image displaying area, and the output surface of said optical bridge is covering both said portion of said image displaying area and said portion of said bezel.

2. A method of seaming images in a video wall, said method comprising the steps of:
(a) providing at least two adjacent digital graphic displays having a gap between them;
(b) providing at least one optical bridge comprising an input surface and an output surface wherein the input surface is smaller than the output surface;
(c) Placing said optical bridge on one of said displays so that its input surface covers only a portion of said image displaying area and its output surface covers said portion of said image displaying area and a portion of said gap; and
(d) Guiding the image from said input surface to said output surface of the optical bridge.

3. The method of claim 2 and further comprising the step of pre-processing the image in a portion of said at least two displays to include image data points that belong to the areas under their bezels.

4. The method of claim 2 and further comprising the steps of pre-processing the image in a portion of said at least two displays as to at least partially compensate for the attenuation of said image by said optical bridge on the images.

5. The method of claim 3 wherein said pre-processing comprises scaling the image in one dimension.

6. The method of claim 4 wherein said pre-processing comprises at least one operation out of a list containing contrast and brightness modification.

7. The method of claim 2 wherein the optical bridge magnifies the image in one dimension, while translating it from the input surface to the output surface.

8. The method of claim 2 wherein each of said at least one optical bridges comprises plurality of light guiding sheets.

9. The method of claim 8 wherein said light guiding sheets are optical fibers.

10. The method of claim 8 wherein said light guiding sheets are thin plates of transparent material coated with reflective layer over at least one of its large face.

11. An optical bridge for seaming images in a video wall comprising at least one prismatic face plate.
